(19) United States
(12) Patent Application Publication
(10) Pub. No.: US 2025/0061629 A1
(43) Pub. Date: Feb. 20, 2025

(54) IMAGE PROCESSING METHOD, APPARATUS, ELECTRONIC DEVICE AND STORAGE MEDIUM

(71) Applicant: Beijing Zitiao Network Technology Co., Ltd., Beijing (CN)

(72) Inventor: Pengjing SONG, Beijing (CN)

(21) Appl. No.: 18/805,516

(22) Filed: Aug. 14, 2024

(30) Foreign Application Priority Data
Aug. 15, 2023 (CN) 202311029854.8

(51) Int. Cl. G06T 11/60; G06T 5/70; G06T 7/12; G06T 7/13

(52) U.S. Cl. CPC G06T 11/60; G06T 5/70; G06T 7/12; G06T 7/13

(57) ABSTRACT

Embodiments of the present disclosure provide an image processing method, an apparatus, an electronic device and a storage medium. The method may includes: acquiring a to-be-processed image, and determining a wipe area of the to-be-processed image; acquiring a replacement pixel value corresponding to a target pixel point in the wipe area, wherein the replacement pixel value is determined based on a boundary pixel point corresponding to the target pixel point, and the boundary pixel point is a projection point of the target pixel point on an area boundary of the wipe area; and setting the corresponding target pixel point according to the replacement pixel value, so as to generate a completed image.

### CROSS-CITATION TO RELATED APPLICATIONS

This application claims the priority to and benefits of the Chinese Patent Application, No. 202311029854.8, which was filed on Aug. 15, 2023. The aforementioned patent application is hereby incorporated by citation in its entirety.

### TECHNICAL FIELD

Embodiments of the present disclosure relate to the field of internet technologies, and in particular to an image processing method, an apparatus, an electronic device and a storage medium.

### BACKGROUND

In a wide variety of applications with image and video editing functions, it is one of the common effect functions to add virtual items to images and videos uploaded by users. In this scenario, the prior art typically involves cutting a target object out of a to-be-processed image by means of image wipe and then performing image completion on the cut-out region based on a background image, thus realizing the effect of wiping off the target object from the to-be-processed image. Afterwards, an effect sticker is inserted into the wiped image, which can further improve the visual effect of this effect.

In the prior art, however, the image wipe scheme has some problems of time-consuming operation and high requirement for hardware performance, bringing an impact on smooth operation of the effect functions.

### SUMMARY

Embodiments of the present disclosure provide an image processing method, an apparatus, an electronic device and a storage medium, so as to overcome the problems of time-consuming operation and high requirement for hardware performance in the exist scheme of wiping and completing images.

In a first aspect, embodiments of the present disclosure provide an image processing method, comprising:
acquiring a to-be-processed image, and determining a wipe area of the to-be-processed image; acquiring a replacement pixel value corresponding to a target pixel point in the wipe area, wherein the replacement pixel value is determined based on a boundary pixel point corresponding to the target pixel point, and the boundary pixel point is a projection point of the target pixel point on an area boundary of the wipe area; and setting a corresponding target pixel point according to the replacement pixel value, so as to generate a completed image.

In a second aspect, embodiments of the present disclosure provide an image processing apparatus, comprising:
an acquiring module configured to acquire a to-be-processed image and determine a wipe area of the to-be-processed image;
a processing module configured to acquire a replacement pixel value

corresponding to a target pixel point in the wipe area, wherein the replacement pixel value is determined based on a boundary pixel point corresponding to the target pixel point, and the boundary pixel point is a projection point of the target pixel point on an area boundary of the wipe area; and
a generating module configured to set the corresponding target pixel point according to the replacement pixel value, so as to generate a completed image.

In a third aspect, embodiments of the present disclosure provide an electronic device, comprising: a processor and a memory;
computer executable instructions are stored in the memory;
the processor executes the computer executable instructions stored in the memory such that the processor executes the image processing method of the first aspect and various possible design of the first aspect.

In a fourth aspect, embodiments of the present disclosure provide a computer readable storage medium, wherein computer executable instructions are stored in the computer readable storage medium, and a processor, when executing the computer executable instructions, implements the image processing method of the first aspect and various possible design of the first aspect.

In a fifth aspect, embodiments of the present disclosure provide a computer program product, comprising a computer program, wherein the computer program, when executed by a processor, implements the image processing method of the first aspect and various possible design of the first aspect.

Embodiments of the present disclosure provide an image processing method, an apparatus, an electronic device and a storage medium, which comprise: acquiring a to-be-processed image, and determining a wipe area of the to-be-processed image; acquiring a replacement pixel value corresponding to a target pixel point in the wipe area, wherein the replacement pixel value is determined based on a boundary pixel point corresponding to the target pixel point, and the boundary pixel point is a projection point of the target pixel point on an area boundary of the wipe area; and setting a corresponding target pixel point according to the replacement pixel value, so as to generate a completed image. By performing pixel computation on the target pixel points inside the wipe area, the pixel values of the boundary pixel points at the edge of the wipe area can be acquired as the replacement pixel values, and the pixel values of the target pixel points can be replaced with the replacement pixel values, thus achieving fast completion for the content inside the wipe area. Taking advantage of the high efficiency of pixel computation, the speed in content completion can be increased, the time required for the computation process can be shortened, and further the requirement for hardware performance can be lowered and effect functions can operate more smoothly.

### BRIEF DESCRIPTION OF DRAWINGS

In order to clearly illustrate the technical solution of the embodiment of the present disclosure or the prior art, the drawings of the embodiments or the prior art will be briefly described in the following; it is obvious that the described drawings are only related to some embodiments of the present disclosure. For an ordinary skilled in the art, other drawings can be obtained according to these drawings without creative work.

FIG. 1 is a diagram showing an application scenario for an image processing

method according to an embodiment of the present disclosure;

FIG. 2 is a first schematic flowchart of the image processing method according to an embodiment of the present disclosure;

FIG. 3 is a schematic diagram of projection points according to an embodiment of the present disclosure;

FIG. 4 is a schematic diagram of another projection points according to an embodiment of the present disclosure;

FIG. 5 is a second schematic flowchart of the image processing method according to an embodiment of the present disclosure;

FIG. 6 is a flowchart of specific implementation of a step S203 in the embodiment shown in FIG. 5;

FIG. 7 is a schematic diagram showing a location of row projection points according to an embodiment of the present disclosure;

FIG. 8 is a schematic diagram showing another location of row projection points according to an embodiment of the present disclosure;

FIG. 9 is a schematic diagram of a column boundary pixel point according to an embodiment of the present disclosure;

FIG. 10 is a flowchart of specific implementation of a step S204 in the embodiment shown in FIG. 5;

FIG. 11 is a schematic diagram of a mirror pixel row according to an embodiment of the present disclosure;

FIG. 12 is a block structural diagram of an image processing apparatus 3 according to an embodiment of the present disclosure;

FIG. 13 is a schematic structural diagram of an electronic device according to an embodiment of the present disclosure; and

FIG. 14 is a schematic structural diagram showing a hardware of an electronic device according to an embodiment of the present disclosure.

### DETAILED DESCRIPTION

In order to make people in the technical field better understand the solution of the present disclosure, the technical solutions in the embodiment of the present disclosure will be described clearly and completely with the attached drawings. Obviously, the described embodiment is only a part of the embodiment of the present disclosure, but not all the embodiments. Based on the embodiments in the disclosure, all other embodiments obtained by an ordinary skilled in this field without creative work belong to the protection scope of the present disclosure.

It should be noted that all user information (including but not limited to user device information, user personal information, etc.) and data (including but not limited to data for analysis, stored data, displayed data, etc.) involved in the present disclosure are information and data authorized by users or fully authorized by all involved parties, and that collection, usage and processing of relevant data are required to comply with relevant laws, regulations and standards of relevant countries and regions, and that corresponding operation portals for the users to choose authorization or denial are offered.

An application scenario for embodiment of the present disclosure will be explained below.

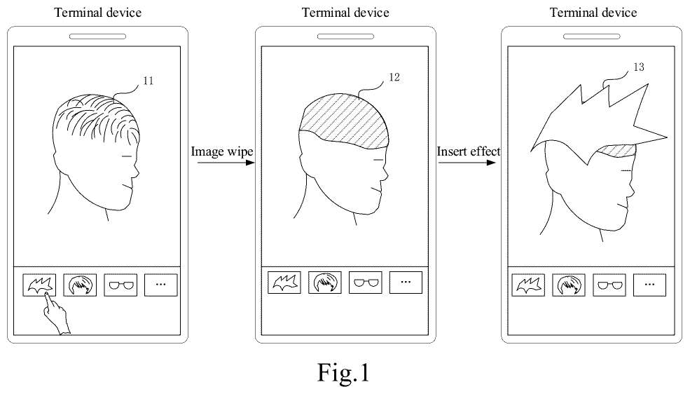

FIG. 1 is a diagram showing an application scenario for an image processing method according to embodiment of the present disclosure. The image processing method according to the embodiments of the present disclosure can be applied to those applications with video editing and image processing functions. More specifically, this image processing method can be applied in an application scenario where effect functions, such as virtual item, sticker, etc., are added to an image. The execution entity for this embodiment may be a terminal device that runs the above applications with video editing and image processing functions, or a server on a server side that corresponds to running of the above applications, or other electronic devices that have a similar function. Referring to FIG. 1, a terminal device is taken as an example. During a process where an effect sticker is added to an initial image by running an application, to avoid an inconsistency between the outline of a target object in the initial image and the outline of the to-be-inserted effect sticker and thus affecting viewing experience, the terminal device firstly needs to perform image wipe on the target object in the initial image, such as hair 11, so that the target object “disappears” from the initial image, and then insert an effect sticker 13 at a location of this target object, i.e., a wipe area 12, thus achieving such an effect that the effect sticker 13 is added to the initial image.

In the prior art, the above effect of wiping off the target object from the image usually needs to be achieved by using a pretrained image processing model. In particular, the target object is firstly cut out from the to-be-processed image, then image features are extracted from a background image and an image completion is performed on the cut-out area on the basis of the image features of the remaining area, by using the pretrained image processing model. In this way, the effect of wiping off the target object from the to-be-processed image is achieved. The scheme in the prior art, however, has the problem that there are a large quantity of model calculations, which leads to a time-consuming image wipe process and higher requirements for hardware performance and further affects the smooth operation of effect functions. An image processing method is provided in the embodiments of the present disclosure to solve the above-mentioned problems.

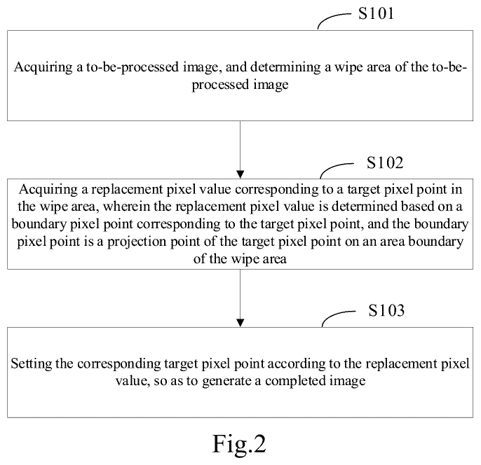

With reference to FIG. 2, FIG. 2 is a first schematic flowchart of the image processing method according to the embodiments of the present disclosure. The method in this embodiment can be applied in an electronic device, such as a terminal device, a server or the like. This image processing method includes:

Step S101: acquiring a to-be-processed image, and determining a wipe area of the to-be-processed image.

Exemplarily, with reference to the schematic diagram of application scenario as shown in FIG. 1, the execution entity for the method according to this embodiment is, for example, a terminal device. After running a corresponding application, the terminal device loads a to-be-processed image based on a user instruction. More specifically, this to-be-processed image is an image to which an effect is to be added. The to-be-processed image may be stored locally at the terminal device, or acquired from outside by the terminal device through, e.g., a network. The specific approach and way for the terminal device to acquire the to-be-processed image is not limited herein, and may be set as needed. Then, the terminal device determines a wipe area of the to-be-processed image. The wipe area is an area in the to-be-processed image that needs to be subjected to image wipe. More specifically, the wipe area is an image area where image content inside the wipe area needs to be deleted (in subsequent steps) and image content outside the wipe area is utilized for image completion to the wipe area.

In a possible implementation, the terminal device can determine the wipe area based on a user instruction. For example, via an interaction interface in the application run by the terminal device, a user draws a designated area in the to-be-processed image, which is taken as the wipe area of this to-be-processed image. In another possible implementation, the terminal device determines the wipe area of the to-be-processed image based on a pre-generated mask image, wherein the mask image may be a matrix of images with the same size in the to-be-processed image, each element in the matrix corresponds to one pixel point of the to-be-processed image, and element values for the matrix elements may be 0 or 1. In this way, the wipe area of the to-be-processed image is characterized by the element values for the matrix elements. The specific implementation of the mask image is regarded as the prior art, so a description thereof is not given here.

Alternatively, the method, after determining the wipe area of the to-be-processed image, further includes:

S1010: adding Gaussian blur for the to-be-processed image.

Gaussian blur is added to the to-be-processed image to reduce differences among the pixel points in the to-be-processed image, and thus to reduce jumps among the pixel points during subsequent completion for the wipe area based on the content in a non-wipe area, thereby enhancing the visual effect of the image.

Further, the method, before adding Gaussian blur, may further include:
acquiring device performance information of a terminal device; determining a Gaussian blur parameter according to the device performance information, the Gaussian blur parameter being used to characterize a number of times the Gaussian blur is performed, and/or a precision of Gaussian blur.

Exemplarily, before adding Gaussian blur, the terminal device determines a parameter of an algorithm for running Gaussian blur, i.e., the Gaussian blur parameter, according to the device performance information. The device performance information includes, for example, hardware identification code, memory size, hardware computing power score, etc. for the terminal device. The data processing performance of the terminal device can be manifested by the device performance information, and based on this device performance information, one Gaussian blur parameter that matches therewith can thus be determined. As a result, terminal devices with worse performance can adopt low-quality Gaussian blur operation to reduce lags, while terminal devices with better performance can adopt high-quality Gaussian blur operation to achieve an improvement in the visual effect and fineness of Gaussian blur.

Accordingly, after the Gaussian blur parameter is determined based on the device performance information, the specific implementation for the process of adding the Gaussian blur in the above step includes: adding Gaussian blur based on the Gaussian blur parameter.

Further, in a possible implementation, the specific implementation for the step S101 includes:

Step S1011: identifying an outline of a target object in the to-be-processed image.

Step S1012: generating a mask image according to the outline of the target object, the mask image being used to characterize the wipe area in the to-be-processed image.

Exemplarily, by identifying the target object in the to-be-processed image after the to-be-processed image is obtained, the outline of the target object can be segmented. The target object is, for example, a particular target or a portion of the particular target, such as a person, a vehicle or the like, in the image. More specifically, the target object is determined based on the type of a triggered target effect, e.g., if the target effect is an effect of adding a “wig” to a portrait, then the corresponding target object which is identified in the to-be-processed image is the “hair” of this person, With the scheme according to this embodiment, it is possible to automatically determine the target object in the to-be-processed image and generate the corresponding mask image, thereby achieving positioning for the target object, i.e., positioning for the wipe area.

Alternatively, the method, after the step S201, may further include:

Step S2011: acquiring effect information, the effect information characterizing an outline shape of the target effect added to the to-be-processed image.

Step S2012: expanding the mask image based on the effect information, so as to update the wipe area in the to-be-processed image.

Exemplarily, the obtained mask image is generated based on the outline of the target object, so during the actual processing, there might be cases where the wipe area corresponding to the mask image is unable to completely cover the target object (i.e., identification for the outline of the target object is inaccurate) when the outline of the target object is relatively complex, which will affect the visual effect of the completed image generated subsequently. In this embodiment, the effect information that characterizes the outline shape of the target effect added to the to-be-processed image, e.g., an effect outline mask image for the target effect, is acquired; the effect outline mask image is then positioned and adaptively scaled in accordance with the location and size of the target object in the to-be-processed image; afterwards, the mask image generated in the previous step is expanded according to the effect outline mask image such that this mask image is able to cover the effect outline mask image; after that, the wipe area is re-determined based on the expanded mask image, that is, the wipe area in the to-be-processed image is updated. By widening the range of the wipe area, the visual effect of the subsequently-generated completed image can be improved.

Step S102: acquiring a replacement pixel value corresponding to a target pixel point in the wipe area, wherein the replacement pixel value is determined based on a boundary pixel point corresponding to the target pixel point, and the boundary pixel point is a projection point of the target pixel point on an area boundary of the wipe area.

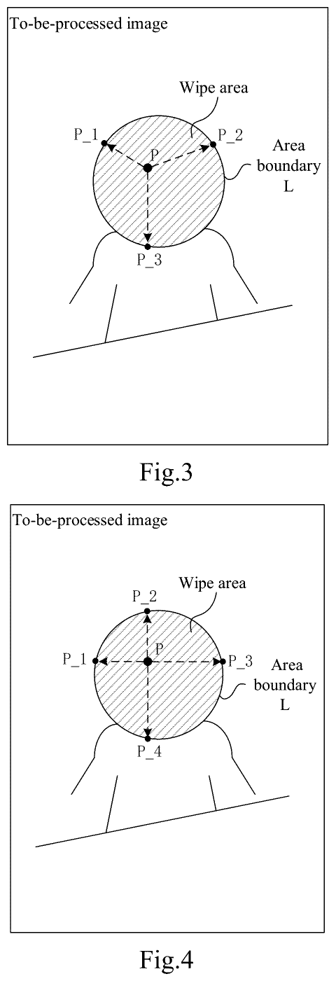

Exemplarily, after the wipe area in the to-be-processed image is determined, a completion operation is carried out, from a pixel dimension, on the image content inside the wipe area. Specifically, the wipe area in the to-be-processed image is determined based on the mask image, the pixel point that falls within the wipe area in the to-be-processed image is the target pixel point. Then, the boundary pixel point corresponding to the target pixel point is selected based on the location of the target pixel point, and the replacement pixel value corresponding to the target pixel point is generated according to the pixel value of the boundary pixel point corresponding to the target pixel point, in order to realize pixel replacement for the pixel value of the target pixel point. The boundary pixel point refers to a projection point of the target pixel point on the area boundary where the target pixel point is located. FIG. 3 is a schematic diagram of projection points according to the embodiments of the present disclosure. Exemplarily, as shown in FIG. 3, a target pixel point P (shown as P in FIG. 3) is present inside the wipe area of the to-be-processed image, the target pixel point P is projected onto the area boundary L of the wipe area where it is located, and in accordance with the direction of projection, different projection points can be obtained on the area boundary L, e.g., P_1, P_2, P_3, etc. shown in FIG. 3. Then, one or more of the projection points P_1, P_2, P_3 can be determined as the boundary pixel point. For example, the projection point P_1 that is closest to the target pixel point P is determined as the boundary pixel point according to the coordinates of the target pixel point and respective projection points. Afterwards, the replacement pixel value of the target pixel point P is obtained according to the pixel value of this boundary pixel point.

FIG. 4 is a schematic diagram of another projection points according to the embodiments of the present disclosure. In another possible implementation, as shown in FIG. 4, the target pixel point P is projected in up, down, left and right directions, respectively, resulting in four projection points P_1, P_2, P_3 and P_4 on the area boundary L of the target pixel point P. Then, boundary pixel points in a lateral direction (pixel row) and in a vertical direction (pixel column) are determined, respectively. Specifically, for example, in P_1 and P_3, the projection point that is closer to the target pixel point P, e.g., P_1, is determined as the row boundary pixel point; similarly, in P_2 and P_4, the projection point that is closer to the target pixel point P, e.g., P_2, is determined as the column boundary pixel point. Then, weighted averaging is carried out according to the pixel value of the row boundary pixel point P_1 and the pixel value of the column boundary pixel point P_2, so as to obtain the replacement pixel value of the target pixel point P.

Step S103: setting a corresponding target pixel point according to the replacement pixel value, so as to generate a completed image.

Exemplarily, after the replacement pixel value corresponding to the target pixel point is obtained, the current pixel value of the corresponding target pixel point is replaced based on the replacement pixel value, achieving the completion for the image content inside the wipe area. The image, which is generated after the above completion process is finished, is the completed image. In a possible implementation, after the wipe area is determined, the transparency of the target pixel point inside the wipe area is set to 0, and after the pixel value of the target pixel point is replaced (set to the replacement pixel value), the transparency of the target pixel point is set to 1, thereby marking up the target pixel point. Then, a target pixel point, which has the transparency of 0 and does not match with any replacement pixel value, can be completed in other ways. By way of example, the pixel value of the target pixel point can be set by acquiring the pixel values of the pixel points in the same pixel column as the target pixel point, so as to realize pixel completion for the above target pixel point with which no replacement pixel value matches.

Alternatively, the method, after the step S103, may further include:

Step S104: adding Gaussian blur for the wipe area in the completed image after the completed image is generated.

Exemplarily, after the completed image is obtained, Gaussian blur can be further added for the wipe area in the completed image, in order to provide smoother transitions between the pixel points of the image content inside the wipe area, reduce mutated pixel points and pixel blocks, and enhance the visual effect of the completed image. The specific implementation of adding Gaussian blur for the wipe area in the completed image is similar to the specific implementation of adding Gaussian blur in the step S1010, so a description thereof is omitted here, and reference may be made to the details in the steps of the above embodiment.

In this embodiment, a to-be-processed image is acquired and a wipe area of the to-be-processed image is determined; a replacement pixel value corresponding to a target pixel point in the wipe area is acquired, wherein the replacement pixel value is determined based on a boundary pixel point corresponding to the target pixel point, and the boundary pixel point is a projection point of the target pixel point on an area boundary of the wipe area; and a corresponding target pixel point is set according to the replacement pixel value, so as to generate a completed image. By performing pixel computation on the target pixel points inside the wipe area, the pixel values of the boundary pixel points at the edge of the wipe area can be acquired as the replacement pixel values, and the pixel values of the target pixel points can be replaced with the replacement pixel values, thus achieving fast completion for the content inside the wipe area. Taking advantage of the high efficiency of pixel computation, the speed in content completion can be increased, the time required for the computation process can be shortened, and further the requirement for hardware performance can be lowered and effect functions can operate more smoothly.

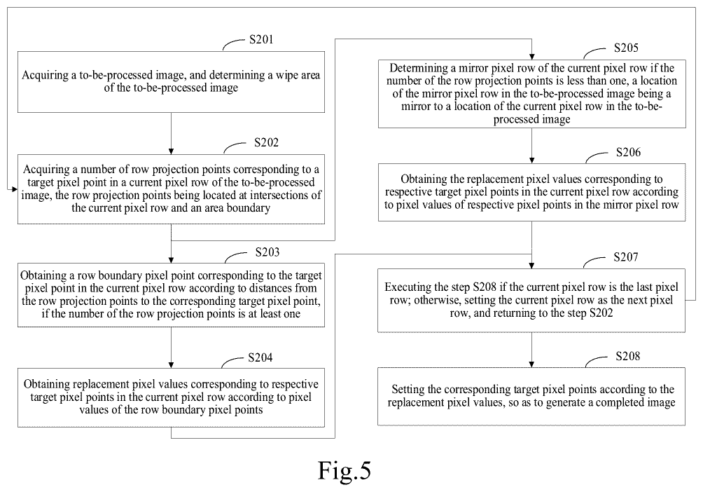

With reference to FIG. 5, FIG. 5 is a second schematic flowchart of the image processing method according to the embodiments of the present disclosure. On the basis of the embodiment shown in FIG. 2, the step S102 is further refined in this embodiment. The image processing method includes:

Step S201: acquiring a to-be-processed image, and determining a wipe area of the to-be-processed image.

Step S202: acquiring a number of row projection points corresponding to a target pixel point in a current pixel row of the to-be-processed image, the row projection points being located at intersections of the current pixel row and the area boundary.

Exemplarily, after the wipe area of the to-be-processed image is determined, in units of pixel rows in the to-be-processed image, the pixel points inside the wipe area are set pixel-row by pixel-row, so as to realize image completion for the wipe area. Specifically, in a possible implementation, the first pixel row of the to-be-processed image (i.e., an uppermost pixel row of the to-be-processed image) is taken as the current pixel row for processing. First of all, the target pixel point in the current pixel row is acquired based on the wipe area marked up by the mask image. For example, the current pixel row includes pixel points P[0] to P[1023], a total of 1024 pixel points, and based on the mask image, pixel points P[24] to P[236] among these pixel points are determined as the target pixel points located inside the wipe area. It will be appreciated that in other possible cases, the target pixel points may include a plurality of inconsecutive pixel points based on the shape of the wipe area, e.g., pixel points P[24] to P[236] and pixel points P[255] to P[1006] are the target pixel points in the current pixel row. Then, by detecting the intersections of the current pixel row and the area boundary, i.e., the row projection point, the number of the row projection points can be obtained. Each target pixel point in the current pixel row has the same corresponding row projection points and the same number of projection points, and thus with one computation, the row projection points, to which the target pixel points correspond, can be rapidly determined, so as to increase the computing efficiency.

Step S203: obtaining a row boundary pixel point corresponding to the target pixel point in the current pixel row according to distances from the row projection points to the corresponding target pixel point, if the number of the row projection points is at least one.

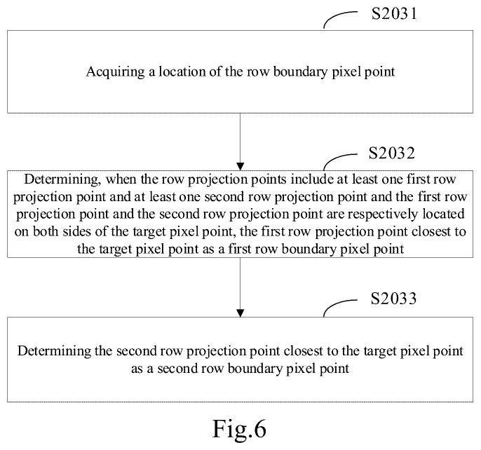

Exemplarily, after the number of the corresponding row projection points is obtained with respect to the current pixel row, processing may differ depending on the number of the row projection points. If the number of the row projection points is larger than or equal to one, i.e., at least one row projection point is included, then it means that there is at least one corresponding non-wipe area in the current pixel row. Therefore, pixel points inside this non-wipe area can be utilized for lateral pixel filling, so as to achieve image completion for the current pixel row. Such a process requires performing computation for every target pixel point one by one, on the basis of positional relationships between the target pixel point and the row projection points, thereby obtaining a row boundary pixel point to which every target pixel point corresponds. Exemplarily, as shown in FIG. 6, the specific implementation of the step S203 includes:

Step S2031: acquiring a location of the row boundary pixel point.

Step S2032: determining, when the row projection points include at least one first row projection point and at least one second row projection point and the first row projection point and the second row projection point are respectively located on both sides of the target pixel point, the first row projection point closest to the target pixel point as a first row boundary pixel point.

Step S2033: determining the second row projection point closest to the target pixel point as a second row boundary pixel point.

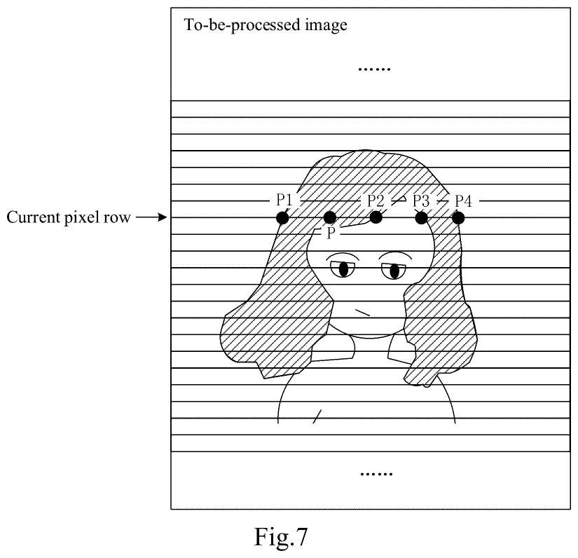

FIG. 7 is a schematic diagram showing locations of row projection points according to the embodiments of the present disclosure. Exemplarily, as shown in FIG. 7, the locations of the row projection points are obtained after a projection point detection is carried out for the current pixel row; when the row projection points include at least one first row projection point and at least one second row projection point and the first row projection point and the second row projection point are respectively located on both sides of the target pixel point, e.g., as shown in the drawing, pixel point P1 is the first row projection point; pixel points P2, P3 and P4 are the second row projection points (shown as P1, P2, P3 and P4, respectively in FIG. 7); and pixel point P is the target pixel point (shown as P in FIG. 7), P1 is determined as the first row boundary pixel point and P2 is determined as the second row boundary pixel point based on the distances from the row projection points to the target projection point. In subsequent steps, the replacement pixel values can be collectively determined based on the pixel values of the first row boundary pixel point and the second row boundary pixel point.

Step S2034: determining, when the row projection points include at least one first row projection point located on a same side of the target pixel point, the first row projection point closest to the target pixel point as a first row boundary pixel point.

Step S2035: determining a pixel point located inside the current pixel row and outside the wipe area, as a second row boundary pixel point.

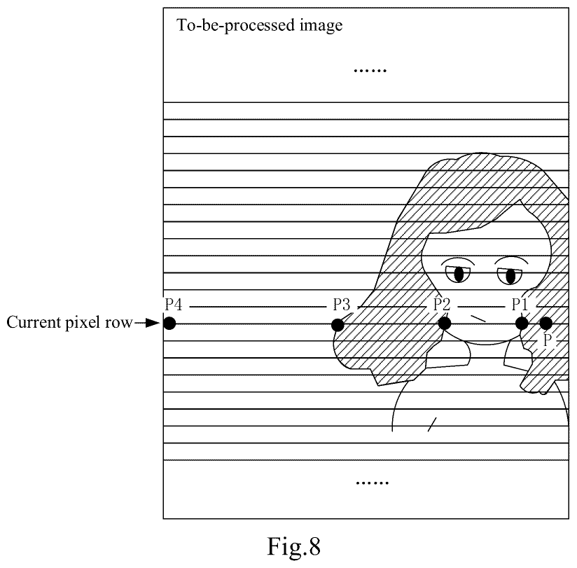

Exemplarily, in another possible implementation, FIG. 8 is a schematic diagram showing another locations of row projection points according to the embodiments of the present disclosure. As shown in FIG. 8, when the row projection points include at least one first projection point located on a same side of the target pixel point, e.g., as shown in the drawing, pixel points P1, P2 and P3 are the first row projection points (shown as P1, P2 and P3 in FIG. 8) and pixel point P (shown as P in FIG. 8) is the target pixel point, P1 is determined as the first row boundary pixel point based on the distances from the first row projection points to the target projection point. Meanwhile, since no boundary pixel point is present on the right side of the target pixel point, in this embodiment, the pixel point located outside the wipe area, e.g., pixel point P4 shown in the drawing (shown as P4 in FIG. 8), is determined as the second row boundary pixel point. In the current pixel row, the pixel point P3 is the first pixel point inside the non-wipe area at a side opposite to the side with no row boundary pixel point (the right side of the target pixel point), e.g., the first pixel point on the leftmost side of the current pixel row.

In a possible implementation, the specific implementation of the step S2035 includes: determining the first row projection point farthest from the target pixel point or an end pixel point of the current pixel row on a side of the first row projection point, as the second row boundary pixel point. With reference to FIG. 8, in addition to the pixel point P3 (the end pixel point of the current pixel row on a side of the first row projection point) in FIG. 8, the second row boundary pixel point may also be the pixel point P4 (the first row projection point that is farthest from the target pixel point) shown in FIG. 8.

In the steps of this embodiment, in a case where no second boundary pixel point is present in the current pixel row, the second boundary pixel point is virtualized by using pixel points on an opposite side away from the image boundary. By doing so, excessive lateral stretching of the image inside the wipe area can be avoided while a sense of symmetry is produced, and thus the visual effect after image completion in case of extensive image wipe is improved.

Step S204: obtaining replacement pixel values corresponding to respective target pixel points in the current pixel row according to pixel values of the row boundary pixel points.

Exemplarily, the row boundary pixel points include a first row boundary pixel point and a second row boundary pixel point. The specific implementation of the step S204 includes:

Step S2041: obtaining a first weighting coefficient corresponding to the first row boundary pixel point and a second weighting coefficient corresponding to the second row boundary pixel point according to distances from the first row boundary pixel point and the second row boundary pixel point to the corresponding target pixel point.

Step S2042: calculating, according to the first weighting coefficient and the second weighting coefficient, a weighted sum of the pixel value of the first row boundary pixel point and the pixel value of the second row boundary pixel point, so as to obtain the replacement pixel value corresponding to the target pixel point.

Exemplarily, after the row boundary pixel points corresponding to the target pixel point are obtained through the above-described calculating step, when there is only one row boundary pixel point corresponding to the target pixel point, the pixel value of this row boundary pixel point can be directly utilized, in a possible implementation, as the replacement pixel value corresponding to the target pixel point. Yet in another possible case, when the row boundary pixel points corresponding to the target pixel point include the first row boundary pixel point and the second row boundary pixel point located on both sides of the target pixel point, in a possible implementation, the row boundary pixel point that is closer to the target pixel point can be determined as a target row boundary pixel point and the replacement pixel value is obtained based on said target row boundary pixel point. In another possible implementation, the first weighting coefficient corresponding to the first row boundary pixel point and the second weighting coefficient corresponding to the second row boundary pixel point are obtained according to the distances from the first row boundary pixel point and the second row boundary pixel point to the corresponding target pixel point. For example, the distance from the first row boundary pixel point to the target pixel point is m, the distance from the second row boundary pixel point to the target pixel point is 4m, and m is a preset unit (i.e., the distance from the second row boundary pixel point to the target pixel point is four times the distance from the first row boundary pixel point to the target pixel point); and accordingly, the distances from the first row boundary pixel point and the second row boundary pixel point to the target pixel point are normalized such that the first weighting coefficient corresponding to the first row boundary pixel point is 0.8 and the second weighting coefficient corresponding to the second row boundary pixel point is 0.2 (i.e., the weighting coefficient is inversely proportional to the distance); then, the weighted sum of a pixel value of the first row boundary pixel point and a pixel value of the second row boundary pixel point are calculated according to the first weighting coefficient and the second weighting coefficient, so as to obtain the replacement pixel value as follows:

$$sum\_value = 0.8 * value\_ 1 + 0.2 * value\_ 2$$

where value_1 is the pixel value of the first row boundary pixel point;
value_2 is the pixel value of the second row boundary pixel point; and
sum_value is the replacement pixel value.

In this embodiment, when the replacement pixel value of the target pixel point is calculated with respect to the current pixel row, pixel values are subjected to weighted summation based on the distances from the target pixel point to the row boundary pixel points on both sides, such that the obtained replacement pixel value can be determined based on the distances from the row boundary pixel points to the target pixel point, and thus the replacement pixel value of the target pixel point can get closer to the pixel value of the image around the target pixel point. In this way, the coherence between the completed image inside the wipe area and the image outside the wipe area can be enhanced, and a better visual effect can be offered.

In another possible implementation, the specific implementation of the step S204 includes:

Step S2043: obtaining a column boundary pixel point corresponding to the target pixel point in the current pixel row.

Step S2044: obtaining the replacement pixel value corresponding to the target pixel point based on a weighted sum of the pixel value of the column boundary pixel point and the pixel value of the row boundary pixel point.

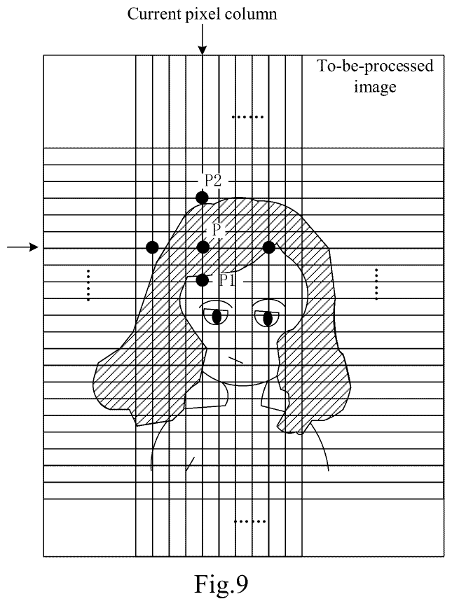

Further, exemplarily, on the basis that the column boundary pixel point is obtained, column boundary pixels, to which the target pixel point in the current pixel row corresponds, can be acquired, wherein the column boundary pixel point is an intersection of the current pixel column and the area boundary, i.e., a column projection point, which is obtained by projecting the target pixel point in a pixel column direction where the target pixel point is located. Then, the column boundary pixel point is obtained through the column projection point. The way of obtaining the column boundary pixel point is similar to the way of obtaining the row boundary pixel point, so for its specific implementation, reference may be made to the description of the previous embodiment about the way of obtaining the row boundary pixel point. FIG. 9 is a schematic diagram of a column boundary pixel point according to the embodiments of the present disclosure. As shown in FIG. 9, in the current pixel row, the target pixel point P is projected in up and down directions, respectively, to obtain intersections of the current pixel column where P is located and the area boundary, i.e., column projection points P1 and P2. Then, P1 is determined as the column boundary pixel point according to the distances from P1 and P2 to the target pixel point. Afterwards, the weighted summation is carried out on the basis of the pixel value of the row boundary pixel point obtained in the previous steps as well as the pixel value of the column boundary pixel point. The weighting coefficients, for example, may be determined based on the distances, so as to obtain the replacement pixel value corresponding to the target pixel point.

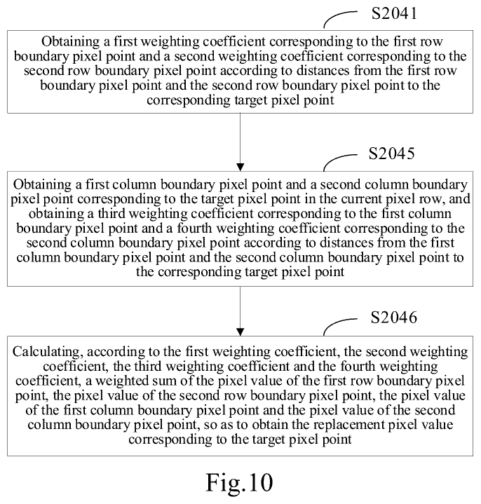

It should be noted that two implementations of the step S204 to which the steps S2041 to S2044 described above correspond, in addition to the case depicted in the above embodiment that they are separately performed, may also be combined to create another implementation of the step S204. Exemplarily, as shown in FIG. 10, the specific implementation of the step S204 includes:

Step S2041: obtaining a first weighting coefficient corresponding to the first row boundary pixel point and a second weighting coefficient corresponding to the second row boundary pixel point according to distances from the first row boundary pixel point and the second row boundary pixel point to the corresponding target pixel point.

Step S2045: obtaining a first column boundary pixel point and a second column boundary pixel point corresponding to the target pixel point in the current pixel row, and obtaining a third weighting coefficient corresponding to the first column boundary pixel point and a fourth weighting coefficient corresponding to the second column boundary pixel point according to distances from the first column boundary pixel point and the second column boundary pixel point to the corresponding target pixel point.

Step S2046: calculating, according to the first weighting coefficient, the second weighting coefficient, the third weighting coefficient and the fourth weighting coefficient, a weighted sum of a pixel value of the first row boundary pixel point, a pixel value of the second row boundary pixel point, a pixel value of the first column boundary pixel point and a pixel value of the second column boundary pixel point, so as to obtain the replacement pixel value corresponding to the target pixel point.

Exemplarily, in the steps of this embodiment, weighted calculation is carried out based respectively on the distances from the first row boundary pixel point, the second row boundary pixel point, the first column boundary pixel point and the second column boundary pixel point to the target pixel point. In this way, the image content on the area boundary around the target pixel point can be fully utilized so that the replacement pixel values corresponding to the target pixel points can realize better transition changes and the visual effect of the image completed inside the wipe area is improved.

Step S205: determining a mirror pixel row of the current pixel row if the number of the row projection points is less than one, a location of the mirror pixel row in the to-be-processed image being a mirror to a location of the current pixel row in the to-be-processed image.

Step S206: obtaining the replacement pixel values corresponding to respective target pixel points in the current pixel row according to pixel values of respective pixel points in the mirror pixel row.

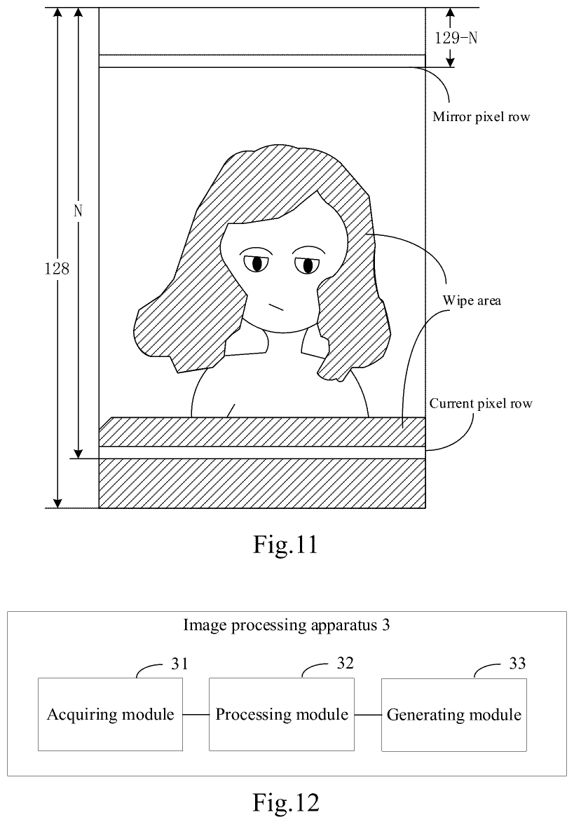

Exemplarily, in another possible case, if the number of the row projection points is less than one, then it may mean that the current pixel row is entirely located inside the wipe area. Here, it is impossible to utilize the image information outside the wipe area in the current pixel row to obtain the corresponding replacement pixel values, and is also impossible to perform image completion on the target pixel points in the current pixel row. In this case, the content of the current pixel row can be completed through pixel rows that have been completed or pixel rows that do not include the wipe area. Specifically, for example, the mirror pixel row of the current pixel row is determined, the location of the mirror pixel row in the to-be-processed image is a mirror to the location of the current pixel row in the to-be-processed image, and then the replacement pixel values corresponding to respective pixel points are integrally determined based on the pixel values of respective pixel points in the mirror pixel row. FIG. 11 is a schematic diagram of a mirror image row according to the embodiments of the present disclosure. As shown in FIG. 11, the total number of the pixel rows in the to-be-processed image is 128 (the 1^{st} row to the 128^{th} row). With regard to processing for the to-be-processed image, when the current pixel row is a pixel row N (N is a positive integer less than or equal to 128), the number of the row projection points is detected to be less than one, which is to say the pixel points of the current pixel row are all located inside the wipe area. At this time, a terminal device acquires a pixel row 129-N of this to-be-processed image. Alternatively, the pixel row 129-N is then detected. If all the pixel points of the pixel row 129-N have a transparency of 1 (i.e., this pixel row has been subjected to image completion, or this pixel row does not include the wipe area), the replacement pixel values of respective pixel points in the pixel row N are respectively determined based on the pixel values of respective pixel points of the pixel row 129-N; if not all the pixel points of the pixel row 129-N have a transparency of 1 (i.e., image completion has not yet been finished), acquiring a pixel row next to this pixel row is performed until the pixel row in which all the pixel points have a transparency of 1 is obtained, and the above step is finished.

In this embodiment, when the number of the row projection points in the current pixel row is less than one, i.e., all of the current pixel row being located inside the wipe area, the corresponding replacement pixel values can be integrally obtained by acquiring the mirror pixel row corresponding to the current pixel row, which further raises the efficiency in completing the image inside the wipe area and shortens the time required for image completion.

Step S207: executing the step S208 if the current pixel row is the last pixel row; otherwise, setting the current pixel row as the next pixel row, and returning to the step S202.

Step S208: setting the corresponding target pixel points according to the replacement pixel values, so as to generate a completed image.

In this embodiment, the implementations of the steps S201 and S208 are same as those of the steps S101 and S103 in the embodiment of the present disclosure as shown in FIG. 2, so a description thereof is omitted herein.

As a counterpart to the image processing method in the above embodiment, FIG. 12 is a block structural diagram of an image processing apparatus 3 according to the embodiments of the present disclosure. For the sake of brevity, only the parts that are related to the embodiments of the present disclosure are shown. Referring to FIG. 12, the image processing apparatus 3 includes:
an acquiring module 31 configured to acquire a to-be-processed image and determine a wipe area of the to-be-processed image;
a processing module 32 configured to acquire a replacement pixel value corresponding to a target pixel point in the wipe area, wherein the replacement pixel value is determined based on a boundary pixel point corresponding to the target pixel point, and the boundary pixel point is a projection point of the target pixel point on an area boundary of the wipe area; and
a generating module 33 configured to set a corresponding target pixel point according to the replacement pixel value, so as to generate a completed image.

In one embodiment of the present disclosure, the processing module 32 is specifically configured to: execute in order, for every pixel row of the to-be-processed image, the following steps of: acquiring a number of row projection points corresponding to the target pixel point in a current pixel row, the row projection points being located at intersections of the current pixel row and the area boundary; obtaining a row boundary pixel point corresponding to the target pixel point in the current pixel row according to a distance from the row projection point to the corresponding target pixel point, if the number of the row projection points is at least one; and obtaining the replacement pixel values corresponding to the target pixel points in the current pixel row according to pixel values of the row boundary pixel points.

In one embodiment of the present disclosure, when the row projection points include at least one first row projection point and/or at least one second row projection point and the first row projection point and the second row projection point are respectively located on both sides of the target pixel point, the processing module 32, when obtaining a row boundary pixel point corresponding to the target pixel point in the current pixel row according to a distance from the row projection point to the corresponding target pixel point, is specifically configured to: determine the first row projection point closest to the target pixel point as a first row boundary pixel point; and/or determine the second row projection point closest to the target pixel point as a second row boundary pixel point.

In one embodiment of the present disclosure, when the row projection points include at least one first row projection point located on a same side of the target pixel point, the processing module 32, when obtaining a row boundary pixel point corresponding to the target pixel point in the current pixel row according to a distance from the row projection point to the corresponding target pixel point, is specifically configured to: determine the first row projection point closest to the target pixel point as a first row boundary pixel point; and determine a pixel point located inside the current pixel row and outside the wipe area, as a second row boundary pixel point.

In one embodiment of the present disclosure, the processing module 32, when determining a pixel point located inside the current pixel row and outside the wipe area, as a second row boundary pixel point, is specifically configured to: determine the first row projection point farthest from the target pixel point or an end pixel point of the current pixel row on a side of the first row projection point, as the second row boundary pixel point.

In one embodiment of the present disclosure, the row boundary pixel point includes a first row boundary pixel point and a second row boundary pixel point; the processing module 32, when obtaining the replacement pixel values corresponding to the target pixel points in the current pixel row according to pixel values of the row boundary pixel points, is specifically configured to: obtain a first weighting coefficient corresponding to the first row boundary pixel point and a second weighting coefficient corresponding to the second row boundary pixel point according to distances from the first row boundary pixel point and the second row boundary pixel point to the corresponding target pixel point; and calculate, according to the first weighting coefficient and the second weighting coefficient, a weighted sum of a pixel value of the first row boundary pixel point and a pixel value of the second row boundary pixel point, so as to obtain the replacement pixel value corresponding to the target pixel point.

In one embodiment of the present disclosure, the processing module 32 is further configured to: obtain a column boundary pixel point corresponding to the target pixel point in the current pixel row; the processing module 32, when obtaining the replacement pixel values corresponding to the target pixel points in the current pixel row according to pixel values of the row boundary pixel points, is specifically configured to: obtain the replacement pixel value corresponding to the target pixel point based on a weighted sum of the pixel value of the column boundary pixel point and the pixel value of the row boundary pixel point.

In one embodiment of the present disclosure, after acquiring a number of row projection points corresponding to the target pixel point in a current pixel row, the processing module 32 is further configured to: determine a mirror pixel row of the current pixel row if the number of the row projection points is less than one, a location of the mirror pixel row in the to-be-processed image being a mirror to a location of the current pixel row in the to-be-processed image; and obtain the replacement pixel values corresponding to respective target pixel points in the current pixel row according to pixel values of respective pixel points in the mirror pixel row.

In one embodiment of the present disclosure, the acquiring module 31 is specifically configured to: identify an outline of a target object in the to-be-processed image; and generate a mask image according to the outline of the target object, the mask image being used to characterize the wipe area in the to-be-processed image.

In one embodiment of the present disclosure, the acquiring module 31, before determining the wipe area of the to-be-processed image according to the mask image, is further configured to: acquire an effect information, the effect information characterizing an outline shape of a target effect added to the to-be-processed image; and expand the mask image based on the effect information, so as to update the wipe area in the to-be-processed image.

In one embodiment of the present disclosure, the processing module is further configured for at least one of the group consisting of: adding Gaussian blur for the to-be-processed image after the wipe area of the to-be-processed image is determined; and adding Gaussian blur for the wipe area in the completed image, after the completed image is generated.

The acquiring module 31, the processing module 32 and the generating module 33 are orderly connected. The image processing apparatus 3 according to this embodiment is able to execute the technical solution of the above-mentioned methods in the embodiments, and since its implementation principle and technical effects are similar, a description thereof is not given here in this embodiment.

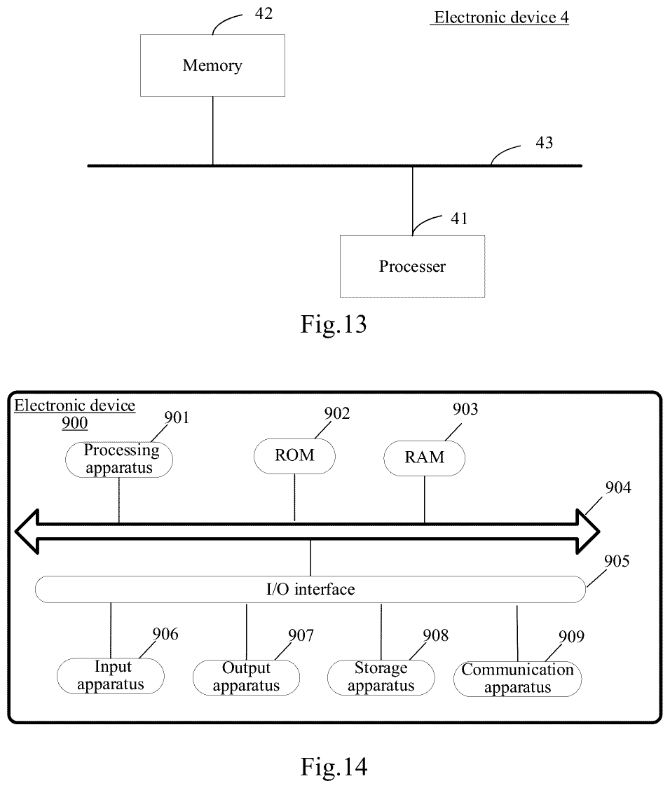

FIG. 13 is a schematic structural diagram of an electronic device according to the embodiments of the present disclosure. As shown in FIG. 13, the electronic device 4 includes:
a processor 41, and a memory 42 communicatively connected with the processor 41;
wherein computer executable instructions are stored in the memory 42;
the processor 41 executes the computer executable instructions stored in the memory 42, so as to implement the image processing method in the embodiment as shown in FIG. 2 to FIG. 11.

Alternatively, the processor 41 and the memory 42 are connected via a bus 43.

For a better understanding of the relevant description, reference may be made to the relevant description and effects to which the steps in the embodiments shown in FIG. 2 to FIG. 11 correspond, so a description thereof is not given here.

Provided in the embodiment of the present disclosure is a computer readable storage medium in which computer executable instructions are stored. The computer executable instructions, when executed by a processor, are used to implement the image processing method according to any of the embodiments of the present disclosure shown in FIG. 2 to FIG. 11.

In order to implement the above-mentioned embodiments, the embodiments of the present disclosure also provide an electronic device.

Referring to FIG. 14, FIG. 14 illustrates a schematic structural diagram of an electronic device 900 suitable for implementing the embodiments of the present disclosure, wherein the electronic device 900 may be a terminal device or a server. The terminal devices in embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 14 is merely an example, and should not pose any limitation to the functions and the range of use of the embodiments of the present disclosure.

As illustrated in FIG. 14, the electronic device 900 may include a processing apparatus 901 (e.g., a central processing unit, a graphics processing unit, etc.), which can perform various suitable actions and processing according to a program stored in a read-only memory (ROM) 902 or a program loaded from a storage apparatus 908 into a random-access memory (RAM) 903. The RAM 903 further stores various programs and data required for operations of the electronic device 900. The processing apparatus 901, the ROM 902, and the RAM 903 are interconnected by means of a bus 904. An input/output (I/O) interface 905 is also connected to the bus 904.

Usually, the following apparatus may be connected to the I/O interface 905: an input apparatus 906 including, for example, a touch screen, a touch pad, a keyboard, a mouse, a camera, a microphone, an accelerometer, a gyroscope, or the like; an output apparatus 907 including, for example, a liquid crystal display (LCD), a loudspeaker, a vibrator, or the like; a storage apparatus 908 including, for example, a magnetic tape, a hard disk, or the like; and a communication apparatus 909. The communication apparatus 909 may allow the electronic device 900 to be in wireless or wired communication with other devices to exchange data. While FIG. 14 illustrates the electronic device 900 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a computer-readable medium. The computer program includes program codes for performing the methods shown in the flowcharts. In such embodiments, the computer program may be downloaded online through the communication apparatus 909 and installed, or may be installed from the storage apparatus 908, or may be installed from the ROM 902. When the computer program is executed by the processing apparatus 901, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to execute the above methods in the embodiments.

The computer program codes for performing the operations of the present disclosure may be written in one or more programming languages or a combination thereof. The above-mentioned programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances. For example, the first acquisition unit can also be described as a “unit for acquiring at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In a first aspect, according to one or more embodiments of the present disclosure, there is provided an image processing method, which comprises:
acquiring a to-be-processed image, and determining a wipe area of the to-be-processed image; acquiring a replacement pixel value corresponding to a target pixel point in the wipe area, wherein the replacement pixel value is determined based on a boundary pixel point corresponding to the target pixel point, and the boundary pixel point is a projection point of the target pixel point on an area boundary of the wipe area; and setting a corresponding target pixel point according to the replacement pixel value, so as to generate a completed image.

According to one or more embodiments of the present disclosure, the acquiring a replacement pixel value corresponding to a target pixel point in the wipe area comprises: executing in order, for every pixel row of the to-be-processed image, the following steps of: acquiring a number of row projection points corresponding to the target pixel point in a current pixel row, the row projection points being located at intersections of the current pixel row and the area boundary; obtaining a row boundary pixel point corresponding to the target pixel point in the current pixel row according to distances from the row projection points to the corresponding target pixel point, if the number of the row projection points is at least one; and obtaining the replacement pixel values corresponding to respective target pixel points in the current pixel row according to pixel values of the row boundary pixel points.

According to one or more embodiments of the present disclosure, when the row projection points comprise at least one first row projection point and/or at least one second row projection point and the first row projection point and the second row projection point are respectively located on both sides of the target pixel point, the obtaining a row boundary pixel point corresponding to the target pixel point in the current pixel row according to distances from the row projection points to the corresponding target pixel point comprises: determining the first row projection point closest to the target pixel point as a first row boundary pixel point; and/or determining the second row projection point closest to the target pixel point as a second row boundary pixel point.

According to one or more embodiments of the present disclosure, when the row projection points comprise at least one first row projection point located on a same side of the target pixel point, the obtaining a row boundary pixel point corresponding to the target pixel point in the current pixel row according to distances from the row projection points to the corresponding target pixel point comprises: determining the first row projection point closest to the target pixel point as a first row boundary pixel point; and determining a pixel point located inside the current pixel row and outside the wipe area, as a second row boundary pixel point.

According to one or more embodiments of the present disclosure, the determining a pixel point located inside the current pixel row and outside the wipe area, as a second row boundary pixel point comprises: determining the first row projection point farthest from the target pixel point or an end pixel point of the current pixel row on a side of the first row projection point, as the second row boundary pixel point.

According to one or more embodiments of the present disclosure, the row boundary pixel points comprise a first row boundary pixel point and a second row boundary pixel point; the obtaining the replacement pixel values corresponding to respective target pixel points in the current pixel row according to pixel values of the row boundary pixel points comprises: obtaining a first weighting coefficient corresponding to the first row boundary pixel point and a second weighting coefficient corresponding to the second row boundary pixel point according to distances from the first row boundary pixel point and the second row boundary pixel point to the corresponding target pixel point; and calculating, according to the first weighting coefficient and the second weighting coefficient, a weighted sum of a pixel value of the first row boundary pixel point and a pixel value of the second row boundary pixel point, so as to obtain the replacement pixel value corresponding to the target pixel point.

According to one or more embodiments of the present disclosure, the method further comprises: obtaining a column boundary pixel point corresponding to the target pixel point in the current pixel row; wherein obtaining replacement pixel values corresponding to respective target pixel points in the current pixel row according to pixel values of the row boundary pixel points comprises: obtaining the replacement pixel value corresponding to the target pixel point based on a weighted sum of a pixel value of the column boundary pixel point and a pixel value of the row boundary pixel point.

According to one or more embodiments of the present disclosure, after the acquiring a number of row projection points corresponding to the target pixel point in a current pixel row, the method further comprises: determining a mirror pixel row of the current pixel row if the number of the row projection points is less than one, a location of the mirror pixel row in the to-be-processed image being a mirror to a location of the current pixel row in the to-be-processed image; and obtaining the replacement pixel values corresponding to respective target pixel points in the current pixel row according to pixel values of respective pixel points in the mirror pixel row.

According to one or more embodiments of the present disclosure, the determining a wipe area of the to-be-processed image comprises: identifying an outline of a target object in the to-be-processed image; and generating a mask image according to the outline of the target object, the mask image being used to characterize the wipe area in the to-be-processed image.

According to one or more embodiments of the present disclosure, before determining the wipe area of the to-be-processed image according to the mask image, the method further comprises: acquiring effect information, the effect information characterizing an outline shape of a target effect added to the to-be-processed image; and expanding the mask image based on the effect information, so as to update the wipe area in the to-be-processed image.

According to one or more embodiments of the present disclosure, the method further comprises at least one selected from the group consisting of: adding Gaussian blur for the to-be-processed image after the wipe area of the to-be-processed image is determined; and adding Gaussian blur for the wipe area in the completed image after the completed image is generated.

According to one or more embodiments of the present disclosure, the method further comprises: acquiring device performance information of a terminal device; determining a Gaussian blur parameter according to the device performance information, the Gaussian blur parameter being used to characterize a number of times the Gaussian blur is performed, and/or a precision of Gaussian blur; wherein the adding Gaussian blur comprises adding Gaussian blur based on the Gaussian blur parameter.

In a second aspect, according to one or more embodiments of the present disclosure, there is provided an image processing apparatus, comprising:
an acquiring module configured to acquire a to-be-processed image and determine a wipe area of the to-be-processed image;
a processing module configured to acquire a replacement pixel value corresponding to a target pixel point in the wipe area, wherein the replacement pixel value is determined based on a boundary pixel point corresponding to the target pixel point, and the boundary pixel point is a projection point of the target pixel point on an area boundary of the wipe area; and
a generating module configured to set the corresponding target pixel point according to the replacement pixel value, so as to generate a completed image.

According to one or more embodiments of the present disclosure, the processing module is specifically configured to: execute in order, for every pixel row of the to-be-processed image, the following steps of: acquiring a number of row projection points corresponding to the target pixel point in a current pixel row, the row projection points being located at intersections of the current pixel row and the area boundary; obtaining a row boundary pixel point corresponding to the target pixel point in the current pixel row according to a distance from the row projection point to the corresponding target pixel point, if the number of the row projection points is at least one; and obtaining the replacement pixel values corresponding to the target pixel points in the current pixel row according to pixel values of the row boundary pixel points.

According to one or more embodiments of the present disclosure, when the row projection points include at least one first row projection point and/or at least one second row projection point and the first row projection point and the second row projection point are respectively located on both sides of the target pixel point, the processing module, when obtaining a row boundary pixel point corresponding to the target pixel point in the current pixel row according to a distance from the row projection point to the corresponding target pixel point, is specifically configured to: determine the first row projection point closest to the target pixel point as a first row boundary pixel point; and/or determine the second row projection point closest to the target pixel point as a second row boundary pixel point.

According to one or more embodiments of the present disclosure, when the row projection points include at least one first row projection point located on a same side of the target pixel point, the processing module, when obtaining a row boundary pixel point corresponding to the target pixel point in the current pixel row according to a distance from the row projection point to the corresponding target pixel point, is specifically configured to: determine the first row projection point closest to the target pixel point as a first row boundary pixel point; and determine a pixel point located inside the current pixel row and outside the wipe area, as a second row boundary pixel point.

According to one or more embodiments of the present disclosure, the processing module, when determining a pixel point located inside the current pixel row and outside the wipe area, as a second row boundary pixel point, is specifically configured to: determine the first row projection point farthest from the target pixel point or an end pixel point of the current pixel row on a side of the first row projection point, as the second row boundary pixel point.

According to one or more embodiments of the present disclosure, the row boundary pixel point includes a first row boundary pixel point and a second row boundary pixel point; the processing module, when obtaining the replacement pixel values corresponding to the target pixel points in the current pixel row according to pixel values of the row boundary pixel points, is specifically configured to: obtain a first weighting coefficient corresponding to the first row boundary pixel point and a second weighting coefficient corresponding to the second row boundary pixel point according to distances from the first row boundary pixel point and the second row boundary pixel point to the corresponding target pixel point; and calculate, according to the first weighting coefficient and the second weighting coefficient, a weighted sum of a pixel value of the first row boundary pixel point and a pixel value of the second row boundary pixel point, so as to obtain the replacement pixel value corresponding to the target pixel point.

According to one or more embodiments of the present disclosure, the processing module is further configured to: obtain a column boundary pixel point corresponding to the target pixel point in the current pixel row; the processing module, when obtaining the replacement pixel values corresponding to the target pixel points in the current pixel row according to pixel values of the row boundary pixel points, is specifically configured to: obtain the replacement pixel value corresponding to the target pixel point based on a weighted sum of the pixel value of the column boundary pixel point and the pixel value of the row boundary pixel point.

According to one or more embodiments of the present disclosure, after the acquiring a number of row projection points corresponding to the target pixel point in a current pixel row, the processing module is further configured to: determine a mirror pixel row of the current pixel row if the number of the row projection points is less than one, a location of the mirror pixel row in the to-be-processed image being a mirror to a location of the current pixel row in the to-be-processed image; and obtain the replacement pixel values corresponding to respective target pixel points in the current pixel row according to pixel values of respective pixel points in the mirror pixel row.

According to one or more embodiments of the present disclosure, the acquiring module is specifically configured to: identify an outline of a target object in the to-be-processed image; and generate a mask image according to the outline of the target object, the mask image being used to characterize the wipe area in the to-be-processed image.

According to one or more embodiments of the present disclosure, the acquiring module, before determining the wipe area of the to-be-processed image according to the mask image, is further configured to: acquire an effect information, the effect information characterizing an outline shape of a target effect added to the to-be-processed image; and expand the mask image based on the effect information, so as to update the wipe area in the to-be-processed image.

According to one or more embodiments of the present disclosure, the processing module is further configured for at least one of the group consisting of: adding Gaussian blur for the to-be-processed image after the wipe area of the to-be-processed image is determined; and adding Gaussian blur for the wipe area in the completed image, after the completed image is generated.

In a third aspect, according to one or more embodiments of the present disclosure, there is provided an electronic device, comprising: a processor and a memory;
computer executable instructions are stored in the memory;
the processor executes the computer executable instructions stored in the memory such that the processor executes the image processing method of the first aspect and various possible design of the first aspect.

In a fourth aspect, according to one or more embodiments of the present disclosure, there is provided a computer readable storage medium, wherein computer executable instructions are stored in the computer readable storage medium, and a processor, when executing the computer executable instructions, implements the image processing method of the first aspect and various possible design of the first aspect.

In a fifth aspect, according to one or more embodiments of the present disclosure, there is provided a computer program product, comprising a computer program, wherein the computer program, when executed by a processor, implements the image processing method of the first aspect and various possible design of the first aspect.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An image processing method, comprising:
acquiring a to-be-processed image, and determining a wipe area of the to-be-processed image;
acquiring a replacement pixel value corresponding to a target pixel point in the wipe area, wherein the replacement pixel value is determined based on a boundary pixel point corresponding to the target pixel point, and the boundary pixel point is a projection point of the target pixel point on an area boundary of the wipe area; and
setting a corresponding target pixel point according to the replacement pixel value, so as to generate a completed image.

2. The method according to claim 1, wherein the acquiring a replacement pixel value corresponding to a target pixel point in the wipe area comprises:
executing in order, for every pixel row of the to-be-processed image, the following steps of:
acquiring a number of row projection points corresponding to the target pixel point in a current pixel row, the row projection points being located at intersections of the current pixel row and the area boundary;
obtaining a row boundary pixel point corresponding to the target pixel point in the current pixel row according to distances from the row projection points to the corresponding target pixel point, if the number of the row projection points is at least one; and
obtaining the replacement pixel values corresponding to respective target pixel points in the current pixel row according to pixel values of the row boundary pixel points.

3. The method according to claim 2, wherein when the row projection points comprise at least one first row projection point and/or at least one second row projection point and the first row projection point and the second row projection point are respectively located on both sides of the target pixel point, the obtaining a row boundary pixel point corresponding to the target pixel point in the current pixel row according to distances from the row projection points to the corresponding target pixel point comprises:
determining the first row projection point closest to the target pixel point as a first row boundary pixel point; and/or
determining the second row projection point closest to the target pixel point as a second row boundary pixel point.

4. The method according to claim 2, wherein when the row projection points comprise at least one first row projection point located on a same side of the target pixel point, the obtaining a row boundary pixel point corresponding to the target pixel point in the current pixel row according to distances from the row projection points to the corresponding target pixel point comprises:
determining the first row projection point closest to the target pixel point as a first row boundary pixel point; and
determining a pixel point located inside the current pixel row and outside the wipe area, as a second row boundary pixel point.

5. The method according to claim 4, wherein the determining a pixel point located inside the current pixel row and outside the wipe area, as a second row boundary pixel point comprises:
determining the first row projection point farthest from the target pixel point or an end pixel point of the current pixel row on a side of the first row projection point, as the second row boundary pixel point.

6. The method according to claim 2, wherein the row boundary pixel points comprise a first row boundary pixel point and a second row boundary pixel point; the obtaining the replacement pixel values corresponding to respective target pixel points in the current pixel row according to pixel values of the row boundary pixel points comprises:
obtaining a first weighting coefficient corresponding to the first row boundary pixel point and a second weighting coefficient corresponding to the second row boundary pixel point according to distances from the first row boundary pixel point and the second row boundary pixel point to the corresponding target pixel point; and
calculating, according to the first weighting coefficient and the second weighting coefficient, a weighted sum of a pixel value of the first row boundary pixel point and a pixel value of the second row boundary pixel point, so as to obtain the replacement pixel value corresponding to the target pixel point.

7. The method according to claim 2, wherein the method further comprises:
obtaining a column boundary pixel point corresponding to the target pixel point in the current pixel row;
wherein obtaining replacement pixel values corresponding to respective target pixel points in the current pixel row according to pixel values of the row boundary pixel points comprises:
obtaining the replacement pixel value corresponding to the target pixel point based on a weighted sum of a pixel value of the column boundary pixel point and a pixel value of the row boundary pixel point.

8. The method according to claim 2, wherein after the acquiring a number of row projection points corresponding to the target pixel point in a current pixel row, the method further comprises:
determining a mirror pixel row of the current pixel row if the number of the row projection points is less than one, a location of the mirror pixel row in the to-be-processed image being a mirror to a location of the current pixel row in the to-be-processed image; and
obtaining the replacement pixel values corresponding to respective target pixel points in the current pixel row according to pixel values of respective pixel points in the mirror pixel row.

9. The method according to claim 1, wherein the determining a wipe area of the to-be-processed image comprises:
identifying an outline of a target object in the to-be-processed image; and
generating a mask image according to the outline of the target object, the mask image being used to characterize the wipe area in the to-be-processed image.

10. The method according to claim 9, wherein before determining the wipe area of the to-be-processed image according to the mask image, the method further comprises:
acquiring effect information, the effect information characterizing an outline shape of a target effect added to the to-be-processed image; and
expanding the mask image based on the effect information, so as to update the wipe area in the to-be-processed image.

11. The method according to claim 1, wherein the method further comprises at least one selected from the group consisting of:
adding Gaussian blur for the to-be-processed image after the wipe area of the to-be-processed image is determined; and
adding Gaussian blur for the wipe area in the completed image after the completed image is generated.

12. The method according to claim 11, wherein the method further comprises:
acquiring device performance information of a terminal device;
determining a Gaussian blur parameter according to the device performance information, the Gaussian blur parameter being used to characterize a number of times the Gaussian blur is performed, and/or a precision of Gaussian blur;
the adding Gaussian blur comprises:
adding Gaussian blur based on the Gaussian blur parameter.

13. An electronic device, comprising: a processor and a memory;
wherein computer executable instructions are stored in the memory;
the processor executes the computer executable instructions stored in the memory such that the processor executes an image processing method,
wherein the image processing method comprises:
acquiring a to-be-processed image, and determining a wipe area of the to-be-processed image;
acquiring a replacement pixel value corresponding to a target pixel point in the wipe area, wherein the replacement pixel value is determined based on a boundary pixel point corresponding to the target pixel point, and the boundary pixel point is a projection point of the target pixel point on an area boundary of the wipe area; and
setting a corresponding target pixel point according to the replacement pixel value, so as to generate a completed image.

14. A computer readable storage medium, wherein computer executable instructions are stored in the computer readable storage medium, and a processor, when executing the computer executable instructions, implements an image processing method,
wherein the image processing method comprises:
acquiring a to-be-processed image, and determining a wipe area of the to-be-processed image;
acquiring a replacement pixel value corresponding to a target pixel point in the wipe area, wherein the replacement pixel value is determined based on a boundary pixel point corresponding to the target pixel point, and the boundary pixel point is a projection point of the target pixel point on an area boundary of the wipe area; and
setting a corresponding target pixel point according to the replacement pixel value, so as to generate a completed image.

15. The electronic device according to claim 13, wherein the acquiring a replacement pixel value corresponding to a target pixel point in the wipe area comprises:
executing in order, for every pixel row of the to-be-processed image, the following steps of:
acquiring a number of row projection points corresponding to the target pixel point in a current pixel row, the row projection points being located at intersections of the current pixel row and the area boundary;
obtaining a row boundary pixel point corresponding to the target pixel point in the current pixel row according to distances from the row projection points to the corresponding target pixel point, if the number of the row projection points is at least one; and
obtaining the replacement pixel values corresponding to respective target pixel points in the current pixel row according to pixel values of the row boundary pixel points.

16. The electronic device according to claim 15, wherein when the row projection points comprise at least one first row projection point and/or at least one second row projection point and the first row projection point and the second row projection point are respectively located on both sides of the target pixel point, the obtaining a row boundary pixel point corresponding to the target pixel point in the current pixel row according to distances from the row projection points to the corresponding target pixel point comprises:
determining the first row projection point closest to the target pixel point as a first row boundary pixel point; and/or
determining the second row projection point closest to the target pixel point as a second row boundary pixel point.

17. The electronic device according to claim 15, wherein when the row projection points comprise at least one first row projection point located on a same side of the target pixel point, the obtaining a row boundary pixel point corresponding to the target pixel point in the current pixel row according to distances from the row projection points to the corresponding target pixel point comprises:
determining the first row projection point closest to the target pixel point as a first row boundary pixel point; and
determining a pixel point located inside the current pixel row and outside the wipe area, as a second row boundary pixel point.

18. The electronic device according to claim 13, wherein the row boundary pixel points comprise a first row boundary pixel point and a second row boundary pixel point; the obtaining the replacement pixel values corresponding to respective target pixel points in the current pixel row according to pixel values of the row boundary pixel points comprises:
obtaining a first weighting coefficient corresponding to the first row boundary pixel point and a second weighting coefficient corresponding to the second row boundary pixel point according to distances from the first row boundary pixel point and the second row boundary pixel point to the corresponding target pixel point; and
calculating, according to the first weighting coefficient and the second weighting coefficient, a weighted sum of a pixel value of the first row boundary pixel point and a pixel value of the second row boundary pixel point, so as to obtain the replacement pixel value corresponding to the target pixel point.

19. The electronic device according to claim 13, wherein the determining a wipe area of the to-be-processed image comprises:
identifying an outline of a target object in the to-be-processed image; and
generating a mask image according to the outline of the target object, the mask image being used to characterize the wipe area in the to-be-processed image.

20. The electronic device according to claim 19, wherein before determining the wipe area of the to-be-processed image according to the mask image, the method further comprises:
acquiring effect information, the effect information characterizing an outline shape of a target effect added to the to-be-processed image; and
expanding the mask image based on the effect information, so as to update the wipe area in the to-be-processed image.
